(19) United States
(12) Patent Application Publication
(10) Pub. No.: US 2023/0238866 A1
(43) Pub. Date: Jul. 27, 2023

(54) VIBRATION MOTOR

(71) Applicant: AAC Microtech (Changzhou) Co., Ltd., Changzhou City (CN)

(72) Inventors: Ziang Li, Shenzhen (CN); Zhiyong Cui, Shenzhen (CN); Yun Tang, Shenzhen (CN); Yao Wang, Shenzhen (CN)

(21) Appl. No.: 17/833,768

(22) Filed: Jun. 6, 2022

(30) Foreign Application Priority Data
Jan. 25, 2022 (CN) 202220208774.3

(51) Int. Cl. H02K 33/04

(52) U.S. Cl. CPC H02K 33/04

(57) ABSTRACT

A vibration motor includes a housing, a driving part, a vibration part, and spring components. The driving part and the vibration part are accommodated in the housing and the spring components are configured to connect the housing and the vibration part to suspend the vibration part in the housing. The vibration part includes a mass block and a magnet part, an accommodation space is defined in the mass block, and the magnet part is disposed in the accommodation space. The magnet part includes two soft magnetic blocks and a magnetic steel, the two soft magnetic blocks are disposed at intervals in a vibration direction of the vibration part, and the magnetic steel is clamped between the two soft magnetic blocks. The present disclosure provides the vibration motor using the single magnetic steel to ensure a driving force.

### TECHNICAL FIELD

The present disclosure relates to the field of vibration motors, and in particular to a vibration motor for portable electronic devices.

### BACKGROUND

In related art, a plurality of magnetic steels are transversely disposed on a vibration motor for ensuring a driving force of the vibration motor, material cost of the plurality of the magnetic steels is so high that manufacturing process difficulty of the vibration motor is accordingly increased.

Therefore, it is necessary to provide a vibration motor to solve above technical problem.

### SUMMARY

The present disclosure aims to provide a vibration motor using a single magnetic steel to ensure a driving force to overcome the above technical problem.

In order to achieve above aims, the present disclosure provides the vibration motor including a housing, a driving part, a vibration part, and spring components. The driving part and the vibration part are accommodated in the housing and the spring components are configured to connect the housing and the vibration part to suspend the vibration part in the housing. The vibration part includes a mass block and a magnet part, an accommodation space is defined in the mass block, and the magnet part is disposed in the accommodation space. The magnet part includes two soft magnetic blocks and a magnetic steel, the two soft magnetic blocks are disposed at intervals in a vibration direction of the vibration part, and the magnetic steel is clamped between the two soft magnetic blocks. The driving part includes at least one coil assembly, and the at least one coil assembly is disposed on one side of the vibration part or symmetrically disposed on two opposite sides of the vibration part, the at least one coil assembly is spaced with respect to the magnet part. The at least one coil assembly includes a pole piece, an iron core, and a coil. The pole piece is fixed to the housing. The iron core is disposed on one side, close to the vibration part, of the pole piece, and the coil is wound around the iron core.

As an improvement, the magnetic steel is magnetized along the vibration direction of the vibration part.

As an improvement, the iron core is disposed opposite to the magnetic steel, and the coil is disposed opposite to the soft magnetic blocks.

As an improvement, the driving part includes the at least one coil assembly, and the at least one coil assembly includes a first coil assembly and a second coil assembly, the first coil assembly and the second coil assembly are symmetrically disposed on the two opposite sides of the vibration part, a current direction of a coil in the first coil assembly is opposite to a current direction of a coil in the second coil assembly.

As an improvement, the at least one coil assembly is at least partially accommodated in the accommodation space.

As an improvement, the vibration motor further includes a limiting block. The limiting block is fixed to the housing, and the limiting block is configured to limit displacement of the vibration part.

The present disclosure provides the vibration motor including driving part and the vibration part. The driving part includes the magnet part, and the magnet part includes the two soft magnetic blocks and the magnetic steel, the two soft magnetic blocks are disposed at intervals in the vibration direction of the vibration part, and the magnetic steel is clamped between the two soft magnetic blocks. The driving part includes the coil assembly, and the coil assembly includes the pole piece, the iron core, and the coil. The pole piece is fixed to the housing. The iron core is disposed on one side, close to the vibration part, of the pole piece. And the coil is wound around the iron core. On the one hand, the single magnetic steel of the vibration motor of the present disclosure saves material cost and reduces difficulty of a manufacturing process of the vibration motor; and on the other hand, the vibration part is subjected to a superposition of an amperometric force and an electromagnetic force, thereby ensuring a driving force.

### BRIEF DESCRIPTION OF DRAWINGS

To more clearly illustrate the technical solutions in the embodiments of the present disclosure clearer, accompanying drawings that need to be used in the description of the embodiments will briefly introduce in following. Obviously, the drawings described below are only some embodiments of the present disclosure. For a person of ordinary skill in the art, other drawings can be obtained according to these without creative labor, wherein:

FIG. 1 is a schematic diagram of a vibration motor of the present disclosure.

FIG. 2 is an exploded schematic diagram of the vibration motor of the present disclosure.

FIG. 3 is a cross-sectional schematic diagram taken along the line A-A shown in FIG. 1.

### DETAILED DESCRIPTION OF EMBODIMENTS

Technical solutions in embodiments of the present disclosure will be clearly and completely described below with reference to accompanying drawings of the embodiments of the present disclosure. Obviously, the described embodiments are merely a part of the embodiments of the present disclosure, rather than all of the embodiments. All other embodiments obtained by those who skilled in the art based on the embodiments of the present disclosure without creative efforts shall fall within protection scopes of the present disclosure.

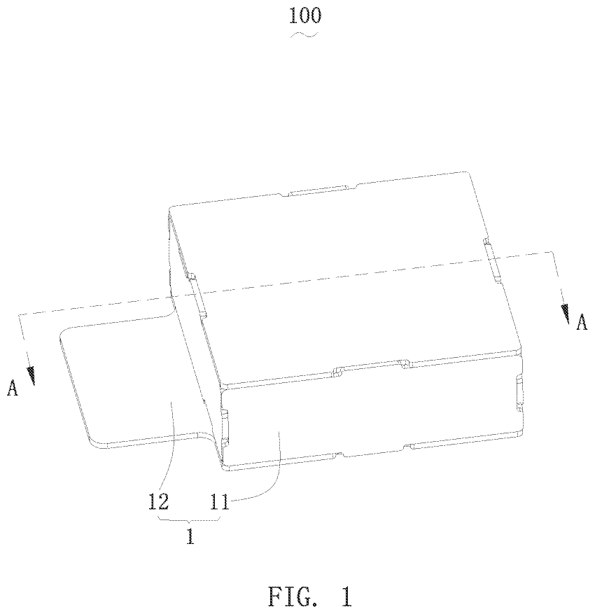

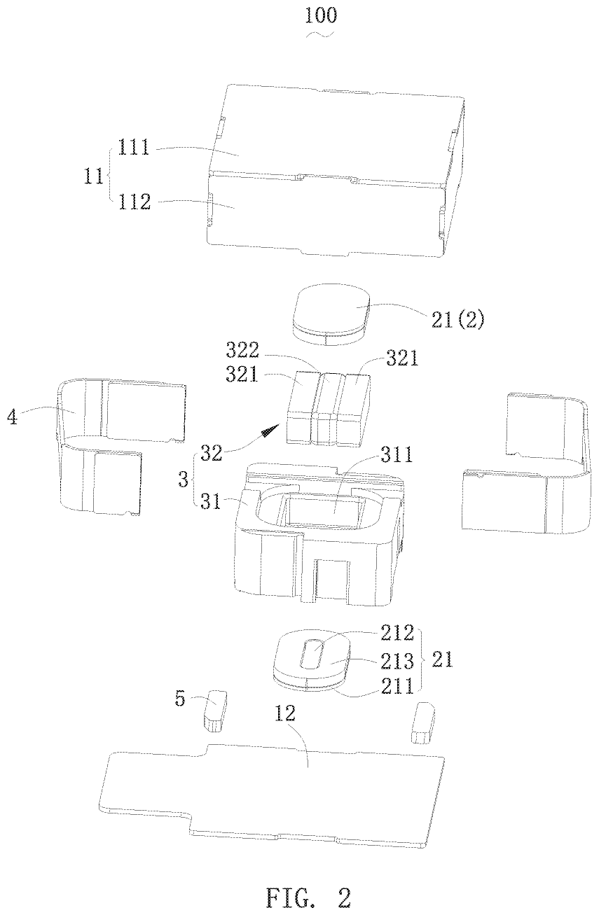

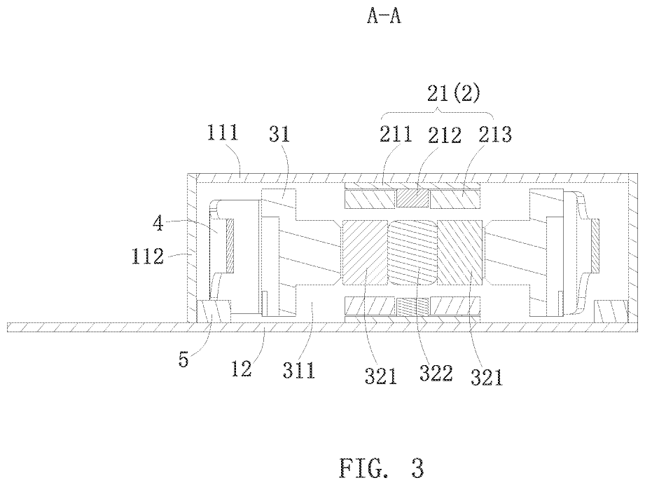

As shown in FIGS. 1-3, the present disclosure provides a vibration motor 100. The vibration motor 100 includes a housing 1, a driving part 2, a vibration part 3, and spring components 4. The driving part 2 and the vibration part 3 are accommodated in the housing 1 and the spring components 4 are configured to connect the housing 1 and the vibration part 3 to suspend the vibration part 3 in the housing 1.

The housing 1 includes a housing body 11 and a bottom plate 12, the bottom plate 12 is connected to the housing 11. The housing body 11 includes a housing top wall 111 and housing sidewalls 112, the housing sidewalls are disposed surrounding the housing top wall 111.

The vibration part 3 includes a mass block 31 and a magnet part 32, an accommodation space 311 is defined in the mass block 31, and the magnet part 32 is disposed in the accommodation space 311. The magnet part 32 includes two soft magnetic blocks 321 and a magnetic steel 322, the two soft magnetic blocks 321 are disposed at intervals in a vibration direction of the vibration part 3, and the magnetic steel 322 is clamped between the two soft magnetic blocks 321. The magnetic steel 322 is magnetized along the vibration direction of the vibration part 3.

The driving part 2 includes a first coil assembly 21 and a second coil assembly 21, the first coil assembly 21 and the second coil assembly 1 are symmetrically disposed on the two opposite sides of the vibration part 3. The first coil assembly 21 is fixed to the housing top wall 111, and the second coil assembly 21 is fixed to the bottom plate 12. Certainly, in other embodiments, the driving part 2 may also include a coil assembly 21 disposed on one side of the vibration part 3, the coil assembly 21 is fixed to the housing top wall 111 or the bottom plate 12.

The coil assembly 21 is spaced with respect to the magnet part 32. The coil assembly 21 includes a pole piece 211, an iron core 212, and a coil 213. The pole piece 211 is fixed to the housing 1. The iron core 212 is disposed on one side, close to the vibration part 3, of the pole piece 211, and the coil 213 is wound around the iron core 212. The iron core 212 is disposed opposite to the magnetic steel 322, and the coil 213 is disposed opposite to the soft magnetic blocks 321. The coil assembly 21 is at least partially accommodated in the accommodation space 311.

In one embodiment, a current direction of the coil 213 in the first coil assembly 21 fixed to the housing top wall 111 is opposite to a current direction of the coil 213 in the second coil assembly 21 fixed to the bottom plate 12.

When the vibration motor 100 works, the coil 213 is subjected to an amperometric force while the vibration part 3 is subjected to a reaction of the amperometric force, the iron core 202 forms an electromagnetic force where the electromagnetic force is repelling at same poles and attracting at different poles between an electromagnet and the magnetic steel 322, a superposition of the amperometric force and the electromagnetic force generates a driving force.

The vibration motor 100 further includes a limiting block 5. The limiting block 5 is fixed to the bottom plate 12, and the limiting block 5 is configured to limit displacement of the vibration part 3.

In order to make objects, technical solutions, and advantages of the present disclosure clearer, embodiments of the present disclosure are described in detail with reference to accompanying drawings in following. A person of ordinary skill in the art can understand that, in the embodiments of the present disclosure, many technical details are provided to make readers better understand the present disclosure

The present disclosure provides the vibration motor including driving part and the vibration part. The driving part includes the magnet part, and the magnet part includes the two soft magnetic blocks and the magnetic steel, the two soft magnetic blocks are disposed at intervals in the vibration direction of the vibration part, and the magnetic steel is clamped between the two soft magnetic blocks. The driving part includes the coil assembly, and the coil assembly includes the pole piece, the iron core, and the coil. The pole piece is fixed to the housing. The iron core is disposed on one side, close to the vibration part, of the pole piece. And the coil is wound around the iron core. On the one hand, the single magnetic steel of the vibration motor of the present disclosure saves material cost and reduces difficulty of a manufacturing process of the vibration motor; and on the other hand, the vibration part is subjected to the superposition of the amperometric force and the electromagnetic force, thereby ensuring the driving force.

The foregoing are merely embodiments of the present disclosure, and it should be noted that, for those who skilled in the art, improvements can be made without departing from the concepts of the present disclosure, but these are all within the protection scopes of the present disclosure.

What is claimed is:

1. A vibration motor, comprising:
a housing;
a driving part;
a vibration part; and
spring components;
wherein the driving part and the vibration part are accommodated in the housing and the spring components are configured to connect the housing and the vibration part to suspend the vibration part in the housing;
wherein the vibration part comprises a mass block and a magnet part, an accommodation space is defined in the mass block, and the magnet part is disposed in the accommodation space; the magnet part comprises two soft magnetic blocks and a magnetic steel, the two soft magnetic blocks are disposed at intervals in a vibration direction of the vibration part, and the magnetic steel is clamped between the two soft magnetic blocks; the driving part comprises at least one coil assembly, and the at least one coil assembly is disposed on one side of the vibration part or symmetrically disposed on two opposite sides of the vibration part, the at least one coil assembly is spaced with respect to the magnet part; the at least one coil assembly comprises a pole piece, an iron core, and a coil; the pole piece is fixed to the housing; the iron core is disposed on one side, close to the vibration part, of the pole piece; and the coil is wound around the iron core.

2. The vibration motor according to claim 1, wherein the magnetic steel is magnetized along the vibration direction of the vibration part.

3. The vibration motor according to claim 1, wherein the iron core is disposed opposite to the magnetic steel, and the coil is disposed opposite to the soft magnetic blocks.

4. The vibration motor according to claim 1, wherein the driving part comprises the at least one coil assembly, and the at least one coil assembly comprises a first coil assembly and a second coil assembly, the first coil assembly and the second coil assembly are symmetrically disposed on the two opposite sides of the vibration part, a current direction of a coil in the first coil assembly is opposite to a current direction of a coil in the second coil assembly.

5. The vibration motor according to claim 1, wherein the at least one coil assembly is at least partially accommodated in the accommodation space.

6. The vibration motor according to claim 1, further comprising:
a limiting block;
wherein the limiting block is fixed to the housing, and the limiting block is configured to limit displacement of the vibration part.
